(19) United States
(12) Patent Application Publication
(10) Pub. No.: US 2008/0063499 A1
(43) Pub. Date: Mar. 13, 2008

(54) FOLDING SUPPORT ARM FOR A LIFTGATE ASSEMBLY

(76) Inventor: Mikko Niinisto, Salo (FI)

Correspondence Address: BROUSE MCDOWELL LPA, 388 SOUTH MAIN STREET, SUITE 500, AKRON, OH, 44311, US

(21) Appl. No.: 11/851,599

(22) Filed: Sep. 7, 2007

Related U.S. Application Data
(60) Provisional application No. 60/824,971, filed on Sep. 8, 2006.

(51) Int. Cl. B60P 1/44; B60P 1/26

(52) U.S. Cl. 414/557; 29/428

(57) ABSTRACT

A liftgate assembly may include a lift assembly for use in moving a platform between a folded position, a lowered position, and a raised position The lift assembly my have a support arm that may include: (1) a first member; (2) a second member having a channel that receives at least a portion of the first member for relative sliding motion; and, (3) a tension spring operatively connected to the first and second members to provide a biasing force to assist in the folding of the platform. The tension spring may be positioned at least partially within the channel.

This application claims priority from U.S. Ser. No. 60/824,971, entitled FOLDING SUPPORT ARM FOR A LIFTGATE ASSEMBLY, filed Sep. 8, 2006, which is incorporated herein by reference.

### I. BACKGROUND OF THE INVENTION

A. Field of Invention

This invention pertains to the art of methods and apparatuses regarding liftgates and more specifically to methods and apparatuses regarding the folding a liftgate platform into and out of a storage condition.

B. Description of the Related Art

It is well known in the art to attach liftgates to vehicle trailers or other forms of vehicle cargo holds to assist with loading and unloading of the vehicles. In general, liftgates include a platform or deck and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some liftgates, sometimes referred to as flip-a-way or fold-up liftgates, are foldable or collapsible into a stowed or storage condition. Often this storage condition is positioned underneath the vehicle cargo hold. When it is desirable to use the liftgate, it can be unfolded out of the storage condition.

U.S. Pat. No. 3,369,679 to Robinson, which is incorporated herein by reference, is titled STOWABLE LIFT APPARATUS and discloses one known example of a foldable liftgate. Robinson provides: a lift apparatus including: (1) a mount frame for use in installing the lift apparatus beneath the bed of a truck; (2) a parallel arm linkage supported to the mount frame; (3) a deck or platform carried by the arm linkage; (4) an actuator operating between the mount frame and the parallel arm linkage for use in elevating the linkage and the deck; and, (5) a linkage spring acting between sections of the linkage for assisting in the folding and unfolding of the deck. The Robinson lift apparatus works well for its intended purpose. It has the disadvantage, however, of exposing the linkage spring to damage and corrosion. It is also know to use an exposed linkage spring similar to that used by Robinson but where the linkage spring has nearly unlimited spring adjustment possibilities, within given limits. While this design has the advantage of a broad range of spring adjustment, it also provides the opportunity for adjustment error.

The present invention provides methods and apparatuses for better protecting the linkage spring from exposure. It also provides methods and apparatuses regarding a new simple linkage spring adjustment. This invention thus overcomes the foregoing difficulties and others while providing better and more advantageous overall results.

### II. SUMMARY OF THE INVENTION

According to one embodiment of this invention, a liftgate assembly may include: a frame member; a mount assembly for use in mounting the liftgate assembly to a vehicle; a platform assembly including a platform; and, a lift assembly for use in moving the platform between a folded position, a lowered position, and a raised position. The lift assembly may have a linkage assembly that includes: (a) at least a first lift arm having a first end operatively connected to the frame member and a second end operatively connected to the platform; and, (b) at least a first support arm having a first end operatively connected to the frame member and a second end operatively connected to the platform. The support arm may include: (1) a first member; (2) a second member having a channel that receives at least a portion of the first member for relative sliding motion; and, (3) a tension spring operatively connected to the first and second members to provide a biasing force to assist in the folding of the platform. The tension spring may be positioned at least partially within the channel.

According to another embodiment of this invention, a method may include the steps of:

providing liftgate assembly including: a frame member; a mount assembly for use in mounting the liftgate assembly to a vehicle; a platform assembly including a platform; and, a lift assembly for use in moving the platform between a folded position, a lowered position, and a raised position. The lift assembly may have a linkage assembly including: (a) at least a first lift arm having a first end operatively connected to the frame member and a second end operatively connected to the platform; and (b) at least a first support arm comprising: a first member; a second member having a channel; and a tension spring;

attaching a first end of the tension spring to the first member;

sliding the first member and the tension spring within the channel in a first direction;

attaching a second end of the tension spring to the second member;

sliding the second member within the channel in a second direction;

attaching a slide limiter to the first support arm to limit the sliding motion of the first member with respect to the second member; and,

attaching a first end of the first support arm to the to the frame member and a second end to the platform.

One advantage of this invention is that the linkage spring is protected from damaging forces and from exposure to corrosive elements.

Another advantage of this invention is that the linkage spring can be easily adjusted to eliminate user adjustment error. This will greatly increase the probability that the spring force will adjusted to the proper specification as set by the manufacturer.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective side view of a liftgate shown in the folded position.

FIG. 2 is a perspective side view of a portion of a vehicle that may receive a liftgate according to this invention.

FIG. 3 is a perspective side view of the liftgate shown in FIG. 1 but shown in the lowered position.

FIG. 4 is a perspective side view of the liftgate shown in FIG. 1 shown in the raised condition.

FIG. 5 is a side perspective view similar to that shown in FIG. 4 but from a different angle.

FIG. 6 is a side perspective assembly view of a support arm according to one embodiment of this invention.

### IV. DETAILED DESCRIPTION OF THE INVENTION

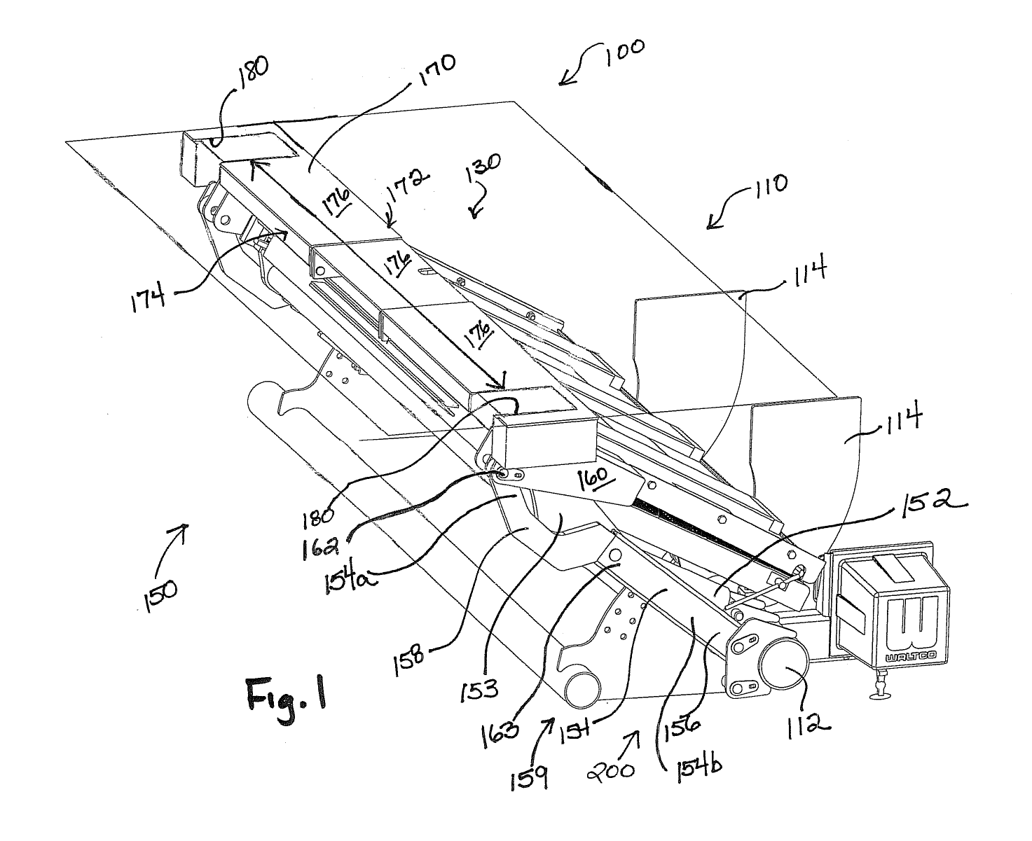

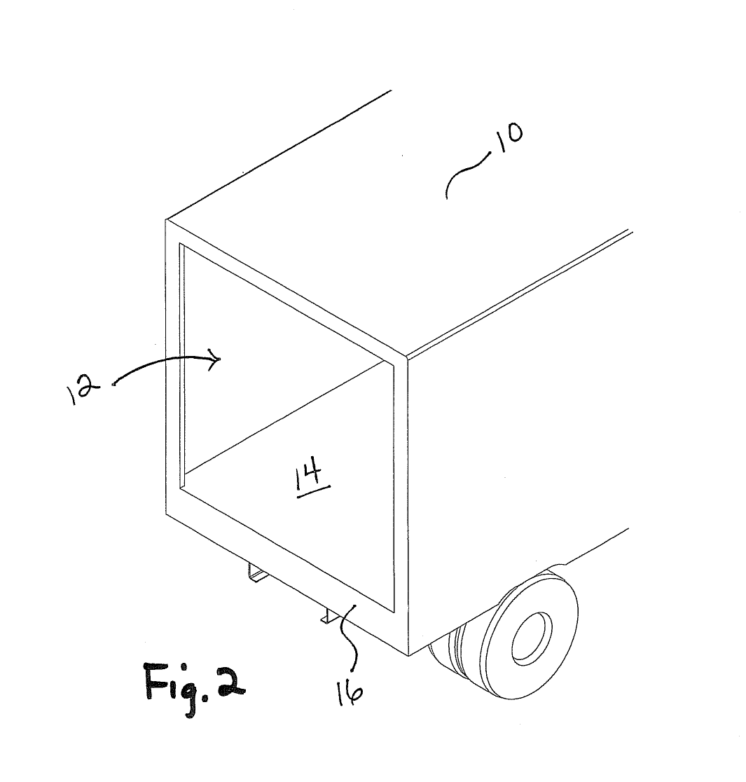

Referring now to the drawings wherein the showings are for purposes of illustrating embodiments of the invention only and not for purposes of limiting the same, FIG. 1 shows a liftgate assembly 100 including a linkage assembly 200 according to this invention. While the liftgate assembly 100 shown is the style known as flip-a-way or fold-up, it is to be noted that this invention may be used with any liftgate style, type and size, when applied with sound engineering judgment. The liftgate assembly 100 may be mounted to a vehicle 10, such as shown in FIG. 2, having a cargo hold 12 with a vehicle bed 14. The vehicle 10 may also have a sill 16 at the outer edge of the cargo hold 12 and conventional vehicle frame members (not shown) to which the liftgate assembly 100 may be attached to the vehicle 10 in any conventional manner. Any type and style of vehicle will work well with this invention when applied with sound engineering judgment.

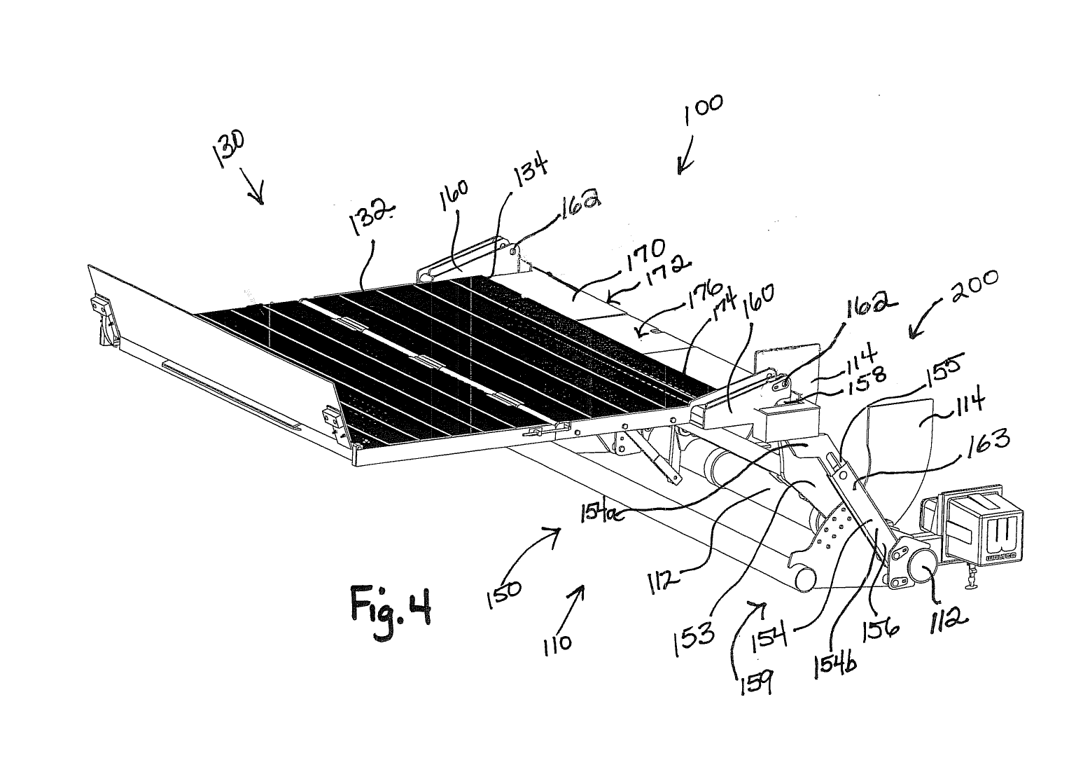

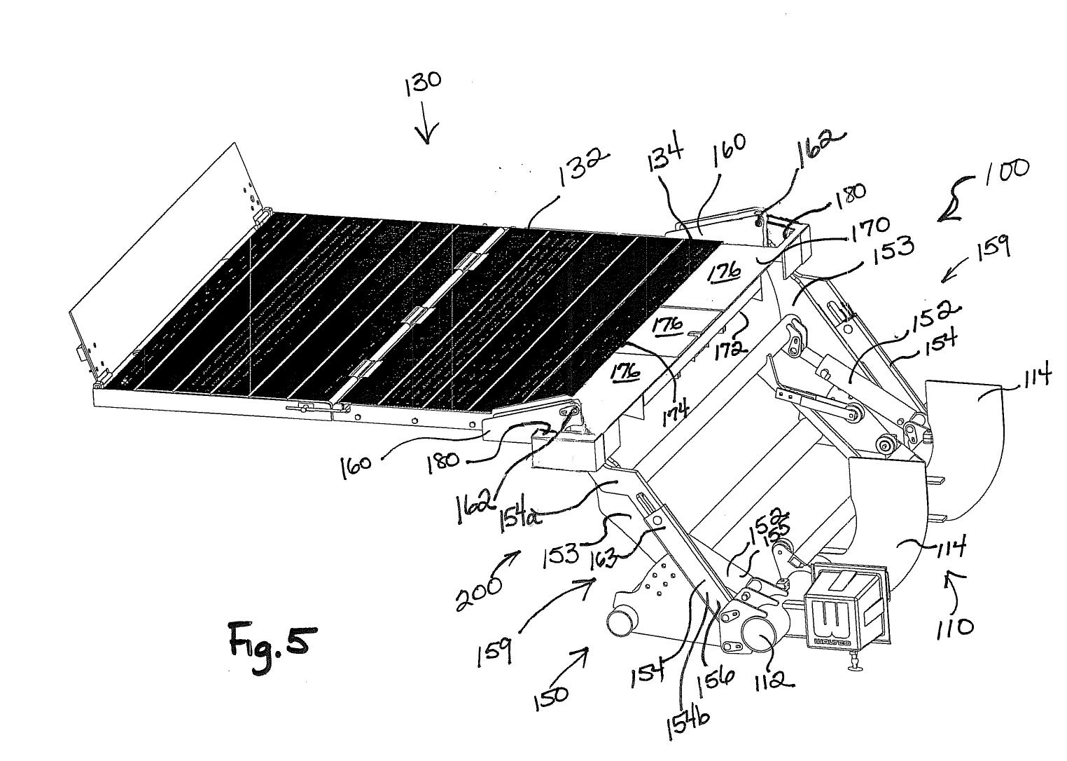

With reference now to FIGS. 1-5, the liftgate assembly 100 may include a mount assembly 110, a platform assembly 130 including a platform or deck 132, a lift assembly 150 and a bed extension 170. The mount assembly 110 may include one or more mounting tubes 112 and one or more mounting plates 114 as well as other components shown but not referenced. The mount assembly 110 is used to mount the liftgate assembly 100 to the vehicle frame in any convention manner and thus will not be described in detail. The bed extension 170 may have a first side 172 that may abut the vehicle 10, such as along the sill 16, and a second side 174 that may abut a first end 134 of the platform 132, as shown. The bed extension 170 may also have a traffic surface 176 that may be used to receive traffic for loading and unloading cargo. A portion of each later to be described bracket member 160, 160 may extend through a corresponding opening 180, 180 defined in the bed extension 170, as shown in FIGS. 4 and 5.

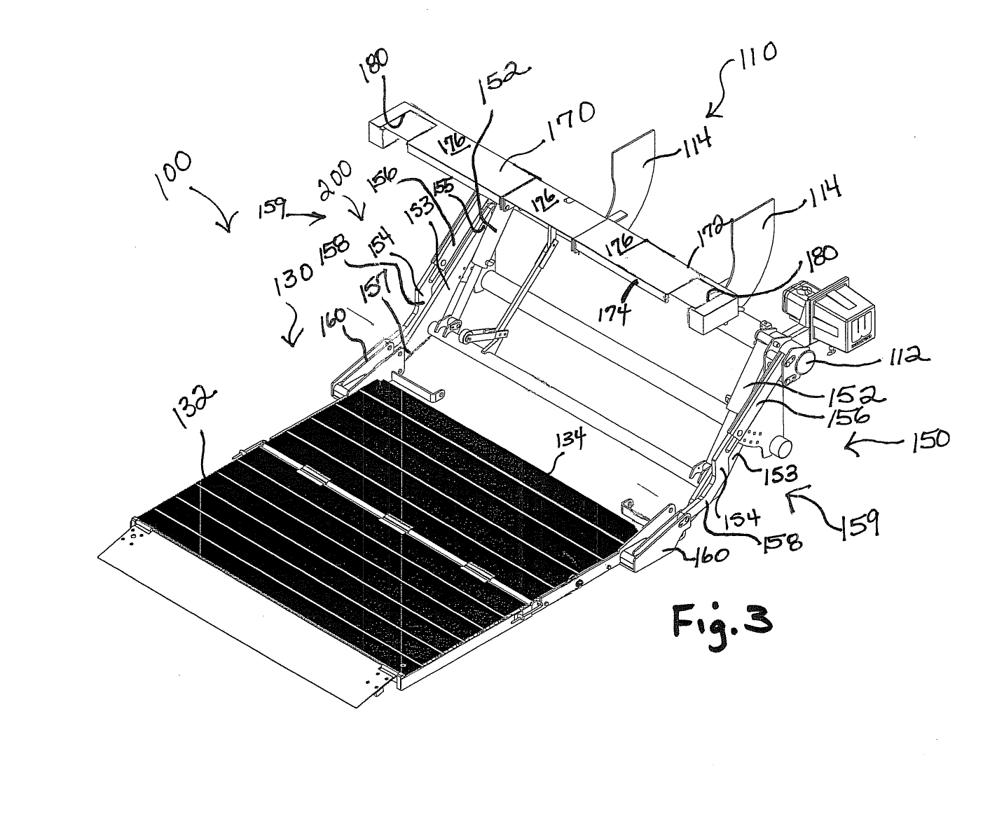

With continuing reference to FIGS. 1-5, the lift assembly 150 is used to move the platform 132 between a folded, closed or storage position (shown in FIG. 1), a lowered position (shown in FIG. 3) and a raised position (shown in FIGS. 4 and 5). The lift assembly 150 may include a control system (not shown) and a hydraulic system (not shown) used to operate one or more cylinders 152 (two visible in FIGS. 3 and 5) to move the platform 132. The basic operation of the control and hydraulic systems are well known and will not be described in detail. The lift assembly 150 may also include the previously noted linkage assembly 200 which supports the platform 132 during its use, its movement, and when in its storage position. The linkage assembly 200 may include a pair of lift arms 153, 153 and a pair of support arms 154, 154. Preferably, the lift arms 153, 153 remain parallel with each other throughout all the motions of the linkage assembly 200. It is similarly preferred that the support arms 154, 154 remain parallel with each other throughout all the motions of the linkage assembly 200. Each lift arm 153, as seen best in FIG. 3, may be operatively attached at a first end 155 to a liftgate frame member (such as mounting tube 112 as shown) and operatively attached at a second end 157 to the platform 132. Each support arm 154, as seen best in FIGS. 1 and 3, may also be operatively attached at a first end 156 to a liftgate frame member (such as mounting tube 112 as shown) and operatively attached at a second end 158 to the platform 132. While the particular types of attachments between each lift arm 153 and each support arm 154 and the frame member and platform 132 can vary according to need, in the embodiments shown, each attachment includes pivotal motion to permit the range of motion desired for the platform 132. According to another embodiment, the previously noted bracket members 160, 160 are fixedly attached (such as by welding) to opposite sides of the platform 132, as shown. A pivot pin 162 permits each second end 157, 158 to pivot with respect to each bracket member 160.

With reference now to FIGS. 1 and 3-6, each support arm 154 may include an expanding mechanism 159, such as a telescoping arrangement, that permits the length of the support arm 154 to be adjusted during the motion of the platform 132. In one embodiment, each support arm 154 includes a first member 154a that at one end 158 attaches to the platform 132, as discussed above, and at the other end 161 is slidably or telescopically received within a second member 154b. The second member 154b may have one end 156 that attaches to the mounting tube 112, as discussed above, and another end 163 that defines a channel 165 that receives the first member 154a. In a more specific embodiment, the channel 165 may extend substantially the full length of the second member 154b. A tension spring 190 may be operatively connected between the first and second members 154a, 154b to provide a biasing force to assist in the folding and unfolding of the liftgate assembly 100 by biasing the first and second members 154a, 154b toward each other. To protect the tension spring 190 from damaging forces and from exposure to corrosive elements, it may be positioned within the channel 165. While the particular design of the channel 165 can be any chosen with sound engineering judgment, to increase the protection of the tension spring 190 the channel 165 may encircle or substantially surround the tension spring 190. For the embodiment shown, this encircling of the tension spring 190 is accomplished by defining the channel 165 with four walls. Other channel shapes and methods for encircling the channel are within applicant's contemplation.

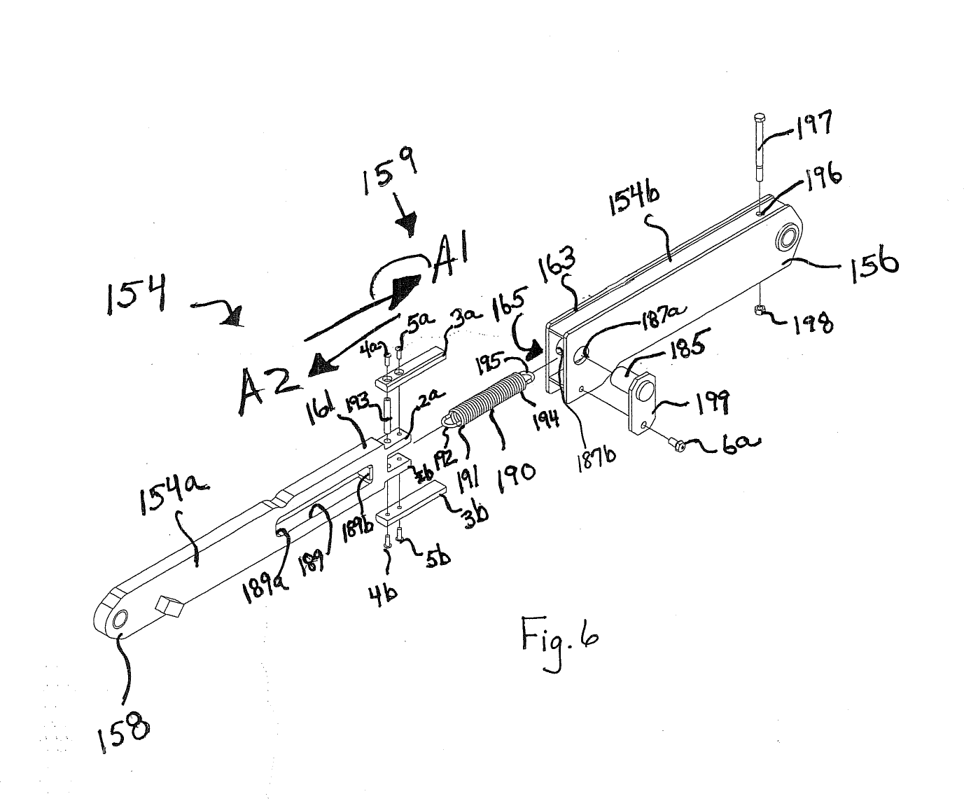

With reference now to FIG. 6, each support arm 154 may be assembled as follows. A first end 191 of the tension spring 190 is connected to the end 161 of the first member 154a. While this connection may be made in any manner chosen with sound engineering judgment, for the embodiment shown a spring attachment loop 192 is positioned between a pair of attachment brackets 2a, 2b that extend from the end 161 of the first member 154a. A connection pin 193 is then inserted through holes formed in the attachment brackets 2a, 2b and through the spring attachment loop 192. The connection pin 193 is then secured to the attachment brackets 2a, 2b so that the spring attachment loop 192 remains attached to the connection pin 193. While this securement may be made in any manner chosen with sound engineering judgment, for the embodiment shown a pair of plates 3a, 3b are attached to outer surfaces of the attachment brackets 2a, 2b. A securing member, such as a screw 4a, is then extended through a hole in at least one plate 3a and received within a threaded opening in one end of the connection pin 193. To increase the stability of the connection, a second securing member, such as a second screw 4b, may be extended through a hole in the plate 3b and received within a threaded opening in the other end of the connection pin 193. To prevent the plates 3a, 3b from pivoting about the screws 4a, 4b, a second hole may be provided in each plate 3a, 3b to receive screws 5a, 5b that are then secured to the brackets 2a, 2b, as shown. In one embodiment, shown, the screws 4a, 4b, 5a, 5b are inset with respect to the outer surfaces of the plates 3a, 3b. In this way, the outer surfaces of the plates 3a, 3b remain relatively smooth and form slide surfaces that are received on the inner surfaces of the channel 165 as the first member 154a moves telescopically with respect to the second member 154b.

With continuing reference to FIG. 6, once the first end 191 of the tension spring 190 is connected to the first member 154a, a second end 194 of the tension spring 190 is connected to the second member 154b. While this connection may be made in any manner chosen with sound engineering judgment, for the embodiment shown the first member 154a is slid within the channel 165 in direction A1 until a spring attachment loop 195 is in alignment with a hole 196 formed in the second member 154b. A connection pin 197 is then inserted through the hole 196 and through the spring attachment loop 195. The connection pin 197 is then secured to the second member 154b so that the spring attachment loop 195 remains attached to the connection pin 197. While this securement may be made in any manner chosen with sound engineering judgment, for the embodiment, shown the distal end of the connection pin 197 is threaded and is extended through another hole (not visible) formed on the opposite side of the second member 154b and received by a nut 198. This single step spring adjustment is easy to accomplish and eliminates user adjustment error. This assures that the biasing force of the tension spring 190 will be the force required by the manufacturer specification.

Still referring to FIG. 6, the first member 154a is then slid within the channel 165 in direction A2 until a portion of a groove 189 formed in the first member 154a is aligned with a first opening 187a formed in the second member 154b. A slide limiter 199, used to limit the sliding motion of the first member 154a with respect to the second member 154b, is then attached to the support arm 154. While this attachment may be made in any manner chosen with sound engineering judgment, for the embodiment shown the slide limiter 199 includes a rod 185 that is inserted through the first opening 187a, through the groove 189 and then extends through a second opening 187b aligned with the first opening 187a but formed in the opposite side of the second member 154b. The slide limiter 199 may be secured in place by a securing member, such as, a screw 6a that is secured to the second member 154b as shown. The slide limiter 199 limits the sliding motion of the first member 154a in direction A1 when a first end surface 189a of the groove 189 contacts the rod 185. Similarly, the slide limiter 199 limits the sliding motion of the first member 154a in direction A2 when a second end surface 189b of the groove 189 contacts the rod 185. The length of the groove 189 can thus be set to determine the range of motion of the first member 154a with respect to the second member 154b.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. In an alternate embodiment, for example, the first member 154a that at one end 158 attaches to the platform 132, may contain the channel 165 while the second member 154b that at one end 156 attaches to the mount assembly 110 may be slidably or telescopically received within the first member 154a.

Having thus described the invention, it is now claimed:

I/We claim:

1. A liftgate assembly comprising:
a frame member;
a mount assembly for use in mounting the liftgate assembly to a vehicle;
a platform assembly including a platform; and,
a lift assembly for use in moving the platform between a folded position, a lowered position, and a raised position, the lift assembly including a linkage assembly comprising:
(a) at least a first lift arm having a first end operatively connected to the frame member and a second end operatively connected to the platform; and,
(b) at least a first support arm having a first end operatively connected to the frame member and a second end operatively connected to the platform, the support arm comprising:
(1) a first member;
(2) a second member having a channel that receives at least a portion of the first member for relative sliding motion; and,
(3) a tension spring operatively connected to the first and second members to provide a biasing force to assist in the folding of the platform, the tension spring being positioned at least partially within the channel.

2. The liftgate assembly of claim 1 wherein the lift assembly further comprises:
(a) a second lift arm having a first end operatively connected to the frame member and a second end operatively connected to the platform, the second lift arm is substantially parallel to the first lift arm;
(b) a second support arm having a first end operatively connected to the frame member and a second end operatively connected to the platform, the second support arm comprising:
(1) a first member;
(2) a second member having a channel that receives at least a portion of the first member for relative sliding motion; and,
(3) a tension spring operatively connected to the first and second members to provide a biasing force to assist in the folding of the platform, the tension spring being positioned at least partially within the channel.
(4) wherein the second support arm is substantially parallel to the first support arm.

3. The liftgate assembly of claim 1 wherein the channel substantially surrounds the tension spring.

4. The liftgate assembly of claim 1 further comprising:
a slide limiter for use in limiting the sliding motion of the first member with respect to the second member.

5. The liftgate assembly of claim 4 wherein:
the first member has a groove;
the second member has an opening into the channel; and,
the slide limiter comprises a rod that may be received in the opening and the groove when the groove is aligned with the opening.

6. The liftgate assembly of claim 4 further comprising:
a securing member that secures the slide limiter to the second member.

7. The liftgate assembly of claim 1 wherein:
a first end of the tension spring comprises a first attachment loop that is connected to a first connection pin that is attached to the first member; and,
a second end of the tension spring comprises a second attachment loop that is connected to a second connection pin that is attached to the second member.

8. The liftgate assembly of claim 7 wherein:
the first member comprises a pair of attachment brackets having holes that receive the first connection pin;
the first connection pin is secured to the pair of attachment brackets with a pair of plates that are attached to opposite outer surfaces of the attachment brackets respectively; and,
a first securing member is extended through a hole in one of the plates and received within an opening in one end of the first connection pin.

9. The liftgate assembly of claim 8 wherein:
a second securing member is extended through a hole in the other plate and received within an opening in the other end of the first connection pin; and,
each plate has an outer surface that forms a slide surface that is received on inner surfaces of the channel.

10. A method comprising the steps of:
providing liftgate assembly comprising: a frame member; a mount assembly for use in mounting the liftgate assembly to a vehicle; a platform assembly including a platform; and, a lift assembly for use in moving the platform between a folded position, a lowered position, and a raised position, the lift assembly including a linkage assembly comprising: (a) at least a first lift arm having a first end operatively connected to the frame member and a second end operatively connected to the platform; and (b) at least a first support arm comprising: a first member; a second member having a channel; and a tension spring;
attaching a first end of the tension spring to the first member;
sliding the first member and the tension spring within the channel in a first direction;
attaching a second end of the tension spring to the second member;
sliding the second member within the channel in a second direction;
attaching a slide limiter to the first support arm to limit the sliding motion of the first member with respect to the second member; and,
attaching a first end of the first support arm to the to the frame member and a second end to the platform.

11. The method of claim 10 further comprising the step of:
securing the slide limiter to the second member.

12. The method of claim 10 wherein:
the step of, attaching a first end of the tension spring to the first member, comprises the step of: attaching a first attachment loop of the tension spring to a first connection pin that is attached to the first member; and,
the step of, attaching a second end of the tension spring to the second member, comprises the step of: attaching a second attachment loop of the tension spring to a to a second connection pin that is attached to the second member.

13. The method of claim 12 wherein the step of, attaching a first attachment loop of the tension spring to a first connection pin that is attached to the first member, comprises the steps of:
providing the first member with a pair of attachment brackets each having a hole;
positioning the first attachment loop between the holes;
inserting the first connection pin through the holes and through the first attachment loop; and,
securing the first connection pin to the pair of attachment brackets.

14. The method of claim 13 wherein the step of, securing the first connection pin to the pair of attachment brackets, comprises the steps of:
attaching a first plate to the outer surface of one of the attachment brackets; and,
extending a first securing member through a hole in the first plate and into an opening in one end of the first connection pin.

15. The method of claim 14 wherein the step of, securing the first connection pin to the pair of attachment brackets, further comprises the steps of:
attaching a second plate to the outer surface of the other attachment bracket; and,
extending a second securing member through a hole in the second plate and into an opening in the other end of the first connection pin.

16. The method of claim 10 wherein the step of, attaching a slide limiter to the first support arm to limit the sliding motion of the first member with respect to the second member, comprises the steps of:
inserting a rod on the slide limiter through an opening formed in one side of the second member and through a groove formed in the first member.

17. The method of claim 10 wherein the step of, sliding the second member within the channel in a second direction, comprises the step of:
sliding the second member in a second direction that is substantially opposite to the first direction.
